(19) United States
(12) Patent Application Publication
(10) Pub. No.: US 2025/0221331 A1
(43) Pub. Date: Jul. 10, 2025

(54) GROUND SPEED CONTROL SYSTEM AND POWER EQUIPMENT UNIT INCORPORATING SAME

(71) Applicant: THE TORO COMPANY, Bloomington, MN (US)

(72) Inventor: Chris A. Wadzinski, Inver Grove Heights, MN (US)

(21) Appl. No.: 18/975,018

(22) Filed: Dec. 10, 2024

Related U.S. Application Data
(60) Provisional application No. 63/618,501, filed on Jan. 8, 2024.

(51) Int. Cl. A01D 34/00; A01D 34/68

(52) U.S. Cl. CPC A01D 34/006; A01D 2034/6843

(57) ABSTRACT

A walk-behind powered equipment unit (e.g., grounds care vehicle such as a power mower) having a ground speed control system. The system may include a handle formed by a handle tube having a proximal end attached to the housing, and a handlebar mounted to the handle tube at a handlebar pivot such that the handlebar may pivot about the handlebar pivot relative to the handle tube in response to a force F applied by the operator to the handlebar, e.g., when the operator walks in a forward direction. An actuator of the handlebar, in response to pivotal motion of the handlebar about the handlebar pivot, imparts a force Fs to a force sensor. The force sensor is configured to produce an electrical sensor signal corresponding to the force F and provide that signal to a propulsion motor.

This application claims priority to and/or the benefit of U.S. Provisional Patent App. No. 63/618,501, filed 8 Jan. 2024, wherein each of the application(s) identified herein above is incorporated by reference in its entirety.

Embodiments of the present disclosure are directed generally to walk-behind powered equipment units (e.g., grounds care vehicles such as power mowers) and, more particularly, to such units having a ground speed control system.

### BACKGROUND

Power equipment units such as power mowers are used by both homeowners and professionals alike to care for turf (or other) surfaces. Such mowers typically include a housing with attached wheels that allow rolling movement over a ground surface. While different mowers are known, a rotary lawn mower may include a housing that forms or otherwise supports a cutting deck having a downwardly facing cutting chamber. The cutting chamber may contain a rotary cutting blade adapted to cut grass and other vegetation. A power source such as an internal combustion engine may also be carried by the housing. The power source may be operatively coupled to the cutting blade to rotate the cutting blade in a generally horizontal cutting plane. The power source may further be operatively coupled to a traction drive of the mower to rotate or power at least some of the wheels, relieving the operator of having to manually propel the mower over the ground surface during operation.

Walk-behind power mowers may typically include an upwardly and rearwardly extending handle attached to the housing to allow a walking operator to guide the mower during operation. Various operational controls, e.g., to allow for engagement/Docket disengagement of blade rotation and/or control of the traction drive, may be provided on the handle. The traction drive may allow variation in ground speed to, for example, better accommodate terrain changes and/or changes in operator walking speed.

### SUMMARY

Embodiments described herein include a power equipment unit having: a housing carrying a working implement; ground-engaging members configured to support the housing upon a ground surface; an electric motor operatively connected to, and adapted to selectively power, one or more of the ground-engaging members to propel the housing over the ground surface at a variable ground speed; and a handle. The handle includes: a handle tube having a proximal end attached to the housing and extending away from the housing to terminate at a distal end; and a handlebar pivotally mounted to the handle tube at a handlebar pivot. The handlebar includes: a grip configured to be grasped by an operator during operation of the power equipment unit whereby the handlebar pivots about the handlebar pivot relative to the handle tube in response to a force F applied to the grip; and an actuator that is offset from the handlebar pivot. The power equipment unit further includes a force sensor operatively connected to the handle tube and configured to contact the actuator such that the actuator, in response to pivotal motion of the handlebar about the handlebar pivot, imparts a force Fs to the force sensor, the force sensor configured to produce an electrical sensor signal corresponding to the force F. A controller is further included, wherein the controller receives the sensor signal and generates an electrical drive command signal to the electric motor to vary a speed or torque output of the electric motor in correspondence to a magnitude of the force F.

In another embodiment, a power equipment unit is provided that includes: a housing carrying a ground-working implement; wheels configured to support the housing upon a ground surface; an electric motor operatively connected to, and adapted to selectively power, one or more of the wheels to propel the housing over the ground surface at a variable ground speed; and a handle. The handle includes: a handle tube having a proximal end attached to the housing and extending away from the housing to terminate at a distal end; and a handlebar pivotally mounted to the handle tube at a handlebar pivot. The handlebar includes: a grip configured for grasping by an operator during operation of the power equipment unit whereby the handlebar pivots about the handlebar pivot relative to the handle tube in response to a force F applied to the grip; and an actuator that is offset from the handlebar pivot. The power equipment unit further includes a force sensor operatively connected to the handle tube and proximate the actuator, wherein in response to pivotal motion of the handlebar about the handlebar pivot, a force Fs is imparted by the actuator to the force sensor, and wherein the force sensor is configured to produce an electrical sensor signal corresponding to the force F. A controller is further included and is configured to receive the sensor signal and generate an electrical drive command signal to the electric motor to vary a speed or torque output of the electric motor in correspondence to a magnitude of the force F.

The above summary is not intended to describe each embodiment or every implementation. Rather, a more complete understanding of illustrative embodiments will become apparent and appreciated by reference to the following Detailed Description of Exemplary Embodiments and claims in view of the accompanying figures of the drawing.

### BRIEF DESCRIPTION OF THE VIEWS OF THE DRAWING

Exemplary embodiments will be further described with reference to the figures of the drawing, wherein:

FIG. 1 is a front perspective view of a power equipment unit (e.g., walk-behind power mower) incorporating a handle and a ground speed control system in accordance with embodiments of the present disclosure;

FIG. 2 is a diagrammatic top plan view of a power mower in accordance with embodiments of the present disclosure;

FIG. 3 is an enlarged partial perspective view of an upper portion of the handle of the mower of FIG. 1;

FIG. 4 is an exploded view of the upper portion of the handle of FIG. 3;

FIG. 5 is an enlarged partial perspective view of the upper portion of the handle of FIG. 3 showing a force sensor in accordance with embodiments of the present disclosure;

FIG. 6 is an isolated perspective view of the force sensor of FIG. 5 exploded from an associated mounting plate;

FIG. 7 is an enlarged side elevation view of the upper portion of the handle of FIG. 3;

FIG. 8 is a section view of the upper portion of the handle taken along line 8-8 of FIG. 3;

FIG. 9 is a diagrammatic side elevation view of a handle in accordance with an alternative embodiment of the present disclosure;

FIG. 10 is a view taken along line 10-10 of FIG. 3; and

FIG. 11 is a diagrammatic view of an exemplary alternative actuator for use with control systems of the present disclosure.

The figures are rendered primarily for clarity and, as a result, are not necessarily drawn to scale. Moreover, various structure/components, including but not limited to fasteners, electrical components (wiring, cables, etc.), and the like, may be shown diagrammatically or removed from some or all of the views to better illustrate aspects of the depicted embodiments, or where inclusion of such structure/components is not necessary to an understanding of the various exemplary embodiments described herein. The lack of illustration/description of such structure/components in a particular figure is, however, not to be interpreted as limiting the scope of the various embodiments in any way.

### DETAILED DESCRIPTION OF EXEMPLARY EMBODIMENTS

In the following detailed description of illustrative embodiments, reference is made to the accompanying figures of the drawing which form a part hereof. It is to be understood that other embodiments, which may not be described and/or illustrated herein, are certainly contemplated.

All headings provided herein are for the convenience of the reader and do not limit the meaning of any text that follows the heading, unless so specified. Moreover, unless otherwise indicated, all numbers expressing quantities, and all terms expressing direction/orientation (e.g., vertical, horizontal, parallel, perpendicular, etc.) in the specification and claims are to be understood as being modified in all instances by the term “about.” The term “and/or” (if used) means one or all of the listed elements or a combination of any two or more of the listed elements. “I.e.” is used as an abbreviation for the Latin phrase id est and means “that is.” “E.g.” is used as an abbreviation for the Latin phrase exempli gratia and means “for example.”

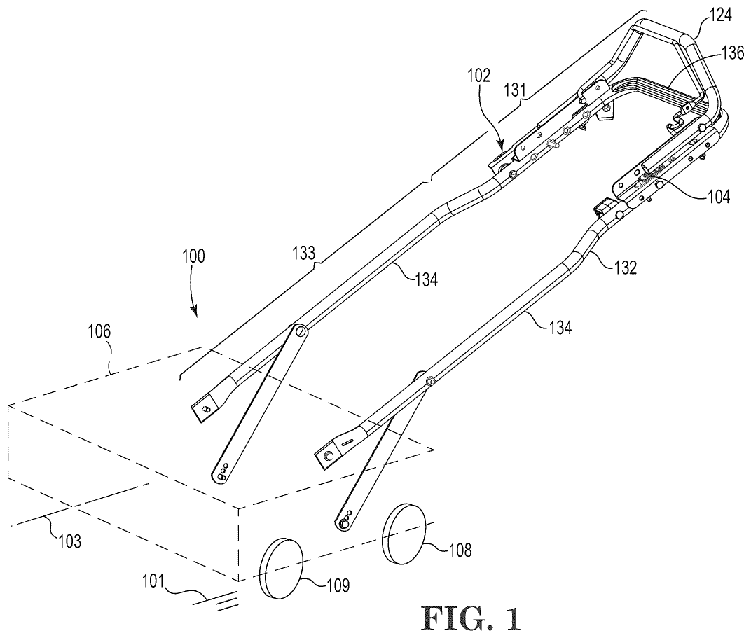

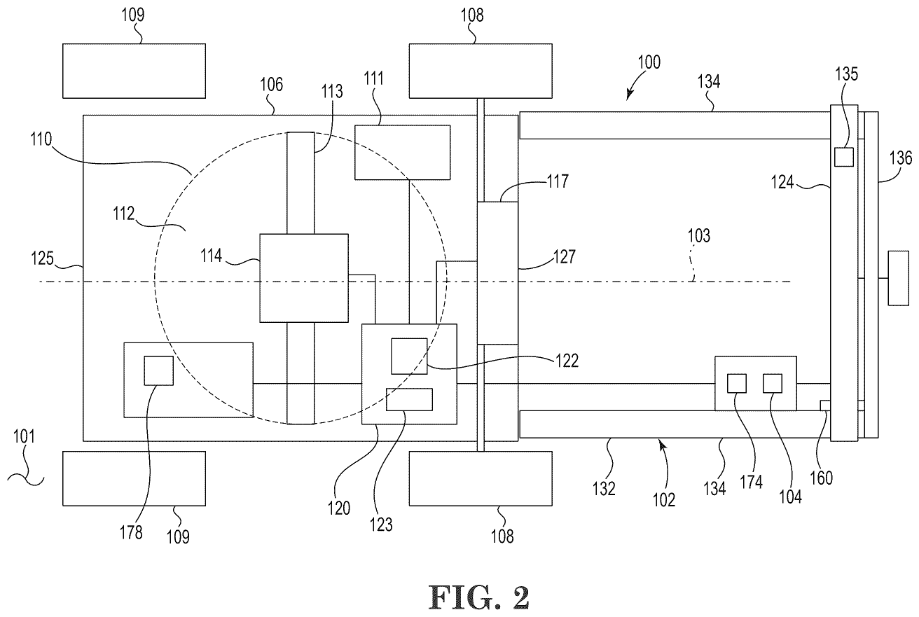

With reference to the figures of the drawing, wherein like reference numerals designate like parts and assemblies throughout the several views, FIGS. 1 and 2 illustrates a walk-behind power equipment unit such as a power mower (see, e.g., mower 100 represented diagrammatically) in accordance with embodiments of the present disclosure. As shown in these views, the mower may include a frame or housing 106 supported upon a ground surface 101 by one or more ground-engaging members (see, e.g., wheels 108, 109). The housing may define a cutting deck 110 that carries a working implement such as a rotary cutting blade 113. An electric motor 117 is operatively connected to, and adapted to selectively power, one or more of the ground-engaging members to propel the housing over the ground surface at a variable ground speed. The mower 100 may also include a handle 102 having: a handle tube with a proximal end attached to the housing and extending away from the housing to terminate at a distal end; and a handlebar 124 pivotally mounted to the handle tube at a handlebar pivot. The handlebar includes a handle grip configured to be grasped by an operator during operation of the power equipment unit whereby the handlebar pivots about the handlebar pivot relative to the handle tube in response to a force applied (e.g., by the operator) to the handle grip (e.g., when the operator walks in a forward direction). The handlebar further includes an actuator that is offset from the handlebar pivot. A force sensor is operatively connected to the handle tube and configured to contact the actuator such that actuator, in response to pivotal motion of the handlebar about the handlebar pivot, imparts a force to the force sensor, the force sensor configured to produce an electrical sensor signal corresponding to the force applied by the operator to the handle grip. The mower further includes a controller that receives the sensor signal and generates an electrical drive command signal to the electric motor to vary a speed or torque output of the electric motor in correspondence to a magnitude of the force applied to the handle grip.

While described and illustrated in the context of a walk-behind power mower 100, such a construction is not limiting as aspects of the depicted/described embodiments may find application to other types of power equipment such as snowthrowers, cultivators, trenchers, debris blowers, dethatchers, aerators, haulers, demolition/construction equipment, and most any other indoor or outdoor ground-working power equipment operated by a walking (or riding) operator. The terms, “mower,” “power mower,” ‘lawn mower,” “walk-behind mower,” and the like may be used interchangeably herein without limitation.

It is noted that the terms “have,” “include,” “comprise,” and variations thereof, do not have a limiting meaning, and are used in their open-ended sense to generally mean “including, but not limited to,” where the terms appear in the accompanying description and claims. Further, “a,” “an,” “the,” “at least one,” and “one or more” are used interchangeably herein. Moreover, relative terms such as “left,” “right,” “front,” “fore,” “forward,” “rear,” “aft,” “rearward,” “top,” “bottom,” “side,” “upper,” “lower,” “above,” “below,” “horizontal,” “vertical,” and the like may be used herein and, if so, are from the perspective of one operating the mower 100 while the mower is in an operating configuration, e.g., while the mower is positioned such that wheels 108, 109 rest upon a generally horizontal surface (e.g., ground surface 101) as shown in FIG. 1. These terms are used only to simplify the description, however, and not to limit the interpretation of any described embodiment. In a similar manner, terms such as “first” and “second” may be used herein to describe various elements. However, such terms are provided merely to simplify identification of the element(s). Accordingly, if an element is described as “first,” there may or may not be any other subsequent elements—that is, a “second” element is not necessarily present. It is further understood that the description of any particular element as being operatively attached, connected, or coupled to another element may indicate that the elements are either directly attached, connected, or coupled to one another, or are indirectly attached, coupled, or connected to one another via intervening elements.

FIG. 1 illustrates a walk-behind power mower 100 having a handle 102 in accordance with embodiments of the present disclosure, while FIG. 2 illustrates a diagrammatic top plan view of the same. As shown in these views, the mower may include the handle 102 and a force sensor 104 (which may, in some embodiments, be mounted to a handle tube 134 of the handle as described in more detail below) responsive to a force applied to a handlebar 124 pivotally mounted to the handle 102 (e.g., by an operator walking behind the mower and grasping a handle grip of the handlebar). The mower 100 (e.g., a frame or housing 106 of the mower) may define a front end 125 and a rear end 127 with a longitudinal or travel axis 103 extending between the front and rear ends (the longitudinal axis 103 being the axis of mower travel when the mower is traveling in a straight line). As used herein, “transverse” may refer to any laterally extending axis (or plane) that is perpendicular to a vertical plane containing the longitudinal axis 103.

As stated above, the mower housing 106 may be supported for movement over the ground surface 101 by a plurality of wheels 108, 109 and may furthermore carry or otherwise form a cutting deck 110 having a downwardly facing cutting chamber 112. A prime mover (e.g., an internal combustion engine, an electric motor 114 powered by an onboard battery pack 111 or the like) may be carried by or otherwise supported by the housing 106. The prime mover may, directly (e.g., via a drive shaft) or indirectly (e.g., via one or more belts or transmissions) power a cutting blade 113 such that the blade may rotate within the cutting chamber 112 as is known in the art. Typically, the cutting deck (or at least the blade 113) has an operator-selectable height-of-cut system to allow blade height adjustment relative to the ground surface 101.

Left and right ground-engaging drive members (e.g., rear drive wheels 108; only left drive wheel visible in FIG. 1) operable to support the housing upon the ground surface 101 may be coupled to left and right sides, respectively, of the housing 106. Each drive wheel may be powered to rotate, relative to the housing 106, about a rotational axis such that rotation of the two drive wheels causes the mower 100 to move parallel to (i.e., along) the longitudinal axis 103. In some embodiments, the drive wheels 108 are operatively coupled to the electric motor 114 (e.g., via a belt-driven transmission) such that the “blade” motor 114 also provides power to the drive wheels. However, as shown in FIG. 2, other embodiments may utilize a separate propulsion motor (or motors) 117 to power the drive wheels 108 and provide the housing with powered movement over the ground surface at a variable ground speed. When a single propulsion motor 117 is utilized, the propulsion motor may include a differential to permit the wheels 108 to rotate differentially so that the operator may easily turn the mower while the motor 117 powers the rear drive wheels. In other embodiments, each wheel 108 may be driven by its own dedicated propulsion motor 117. Accordingly, while the blade 113 is operatively powered by a first electric motor (e.g., the blade motor 114), a second electric motor (e.g., the propulsion motor 117) may be operatively connected to, and adapted to selectively power, the drive wheels 108.

The mower 100 may include additional wheels 109 to support, for example, a front portion of the mower in rolling engagement with the ground surface 101. While described herein as utilizing two rear drive wheels and two front wheels, such a configuration is merely exemplary. For example, other embodiments may use more or less wheels (e.g., a tri-wheel configuration), while still other embodiments may provide different drive wheel configurations (e.g., front-wheel drive or all-wheel drive) or different steering configurations (e.g., a vehicle with conventional Ackermann-type steering). Still further, one or more of the wheels may caster to assist with steering the mower during operation. While illustrated herein as wheels, other embodiments may utilize other ground-engaging members (e.g., rollers, tracks, or the like) without departing from the scope of this disclosure.

As shown in FIG. 2, the mower may include a powered implement for performing a ground grooming or ground working operation. In the illustrated embodiments, the implement is configured as a vegetation/grass cutting blade 113 carried by the housing 106 and operatively coupled to a drive shaft of the blade motor 114. While not illustrated, grass clippings generated by mowing with the cutting blade may be ejected into and captured by a collection bag (when the mower is in a bagging mode) or, where the bag is removed and a discharge door (not shown) is closed, the clippings may be distributed over the ground surface 101 (when the mower is configured in a mulching mode). The mower may optionally include an attachment to also permit side discharge of lawn clippings (when the mower is configured in a side discharge mode).

Electrical systems of the mower, including the blade motor 114 and the propulsion motor 117, may receive power from the onboard battery pack 111 (see FIG. 2), which may be detachable for re-charging and/or designed to be charged while installed on the mower.

The mower may thus be described as including a blade or implement drive system (which includes the blade 113, blade motor 114, and associated controls), and a traction drive system (which includes the drive wheels 108, the propulsion motor 117 and associated controls). While the traction drive system is described herein as providing propulsion of the mower 100 over the ground surface in a forward direction at a variable ground speed, it may, in other embodiments, be configured to provide propulsion at variable ground speeds in a reverse direction, or in both forward and reverse directions. As used herein, variable ground speed indicates that the ground speed may be infinitely variable or variable in small, discrete steps.

As further shown in FIGS. 1 and 2, the exemplary mower 100 may include the handle 102 extending rearwardly (and, in the illustrated embodiment, upwardly) from the housing 106. The handle 102 is configured to allow an operator to guide the housing during powered movement over the ground surface 101 from an operator position behind the mower/handle. While the exact configuration may vary, the handle 102 may include a handle frame 132 attached to the rear of the housing 106. The handle 102/handle frame 132 may further include a lower portion 133 attached to the housing 106, and an upper portion 131 to which various operating controls are attached. In some embodiments, the handle frame 132 may be formed by two handle tubes 134 joined together near their distal or upper ends by a cross tube or member 136 such that the handle frame 132 forms a generally U-shaped structure or member.

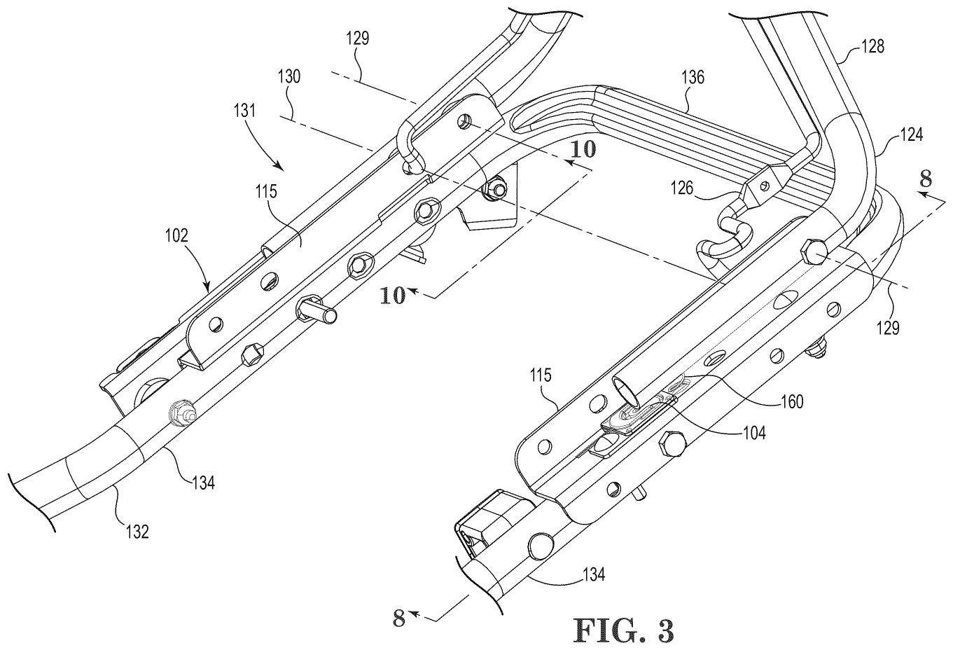

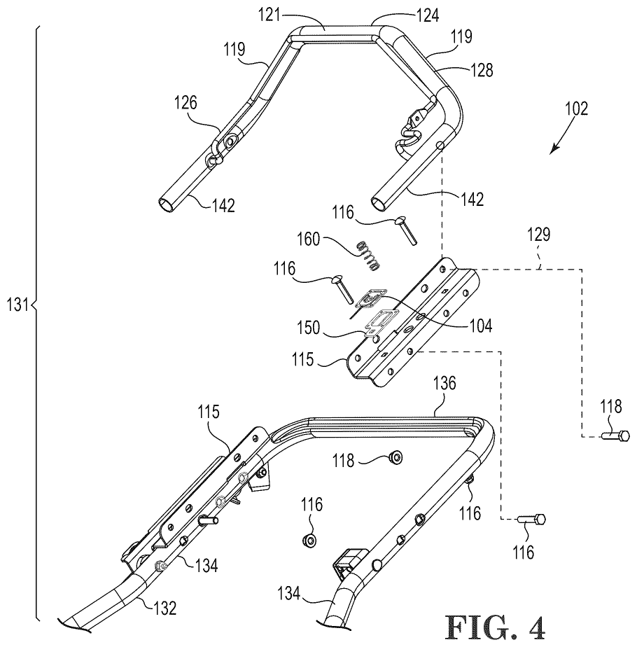

FIG. 3 illustrates the upper portion 131 of the handle 102 in isolation, while FIG. 4 shown the same portion in an exploded view. As shown in these views, the upper portion 131 of the handle 102 may form or otherwise carry the laterally extending handlebar 124 movably (e.g., pivotally) mounted to the handle frame 132/tubes 134. The handlebar 124 may include a grip portion (also referred to herein as “handle grip” or “grip”) 128 sized to allow the operator to grip the handle grip (e.g., with both hands) and thereby guide the mower housing during operation. The handlebar 124 may further include a pair of legs 142 to permit mounting the handlebar to the handle frame 132 (e.g., to the tubes 134) such that the handlebar 124 moves, e.g., pivots, relative to the handle frame. As shown in FIG. 2, the handlebar 124 (e.g., the handle grip 128) may include an optional sensor 135 that may be used, for example, to detect operator presence.

The mower (e.g., handle 102) may include various operating controls with which the operator may interact, including controls for actuating and/or controlling both the traction drive system (e.g., propulsion motor 117) and the blade drive system (e.g., blade motor 114). For instance, the control(s) may include a traction control that controls a propulsion speed of the mower 100 (e.g., via the traction drive system). In the illustrated embodiments, the traction control may include the handlebar 124 and the associated force sensor 104 as further described below.

The control(s) carried by the handle 102 may further include an implement control that, in one embodiment, selectively engages/disengages the blade 113 (e.g., actuates/de-actuates the blade motor 114). As shown in FIGS. 3 and 4, the implement control may comprise a laterally extending, pivoting bail 126 having a shape that generally mimics that of handle grip 128. While the bail 126 is illustrated forward of handle grip 128, other positions of the bail 126 relative to handle grip 128 are also possible. The term “implement control” is understood to include not only the bail 126, but most any control that may be used to actuate/de-actuate the implement (e.g., blade 113).

To initiate blade 113 (motor 114) rotation, the bail 126 may be pivoted from the open position (not shown, but generally at a position spaced-apart from the handle grip 128) about a bail pivot axis 130 (see FIG. 3) to a closed position as shown in FIGS. 3 and 4. When the bail 126 is in the closed position, a circuit providing power to the electric blade motor 114 is closed allowing the motor to rotate the cutting blade 113 (assuming related interlocks are in the correct state). Blade engagement may continue for so long as the operator holds the bail 126 in the closed position. The bail 126 may be biased such that it may automatically return to its open position relative to (i.e., spaced-away from) the handle grip 128 to disengage the blade/blade motor when the operator releases the bail. In some embodiments, a secondary action, e.g., actuating a bail latch, may be needed in order for the operator to move the bail 126 to the closed position, e.g., to mitigate inadvertently starting the blade motor 114.

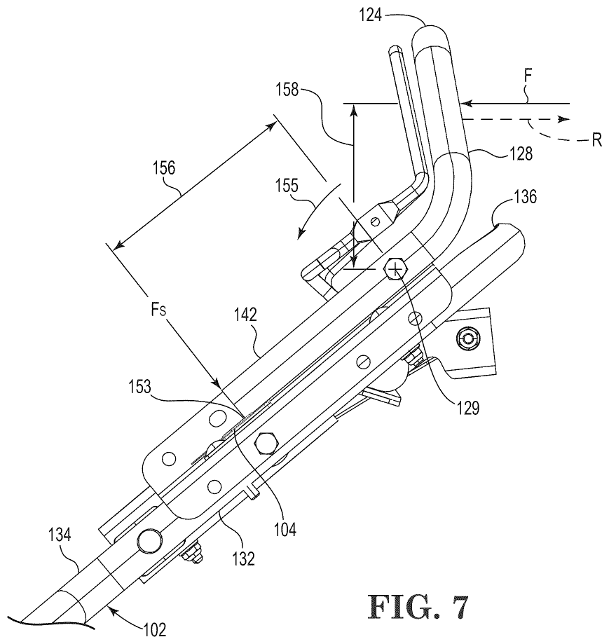

As stated above, the handlebar 124 may be configured to pivot, e.g., about a handlebar pivot 129 (see FIG. 3) relative to the handle frame 132 when a forward force F (see FIG. 7) is applied to the handlebar/handle grip 128, e.g., resulting from the operator gripping the handle grip with his/her hands and walking in the forward direction. As also stated above, the handlebar 124 could optionally move in the reverse direction relative to handle frame 132 when a rearward force R is applied by the operator to handlebar, e.g., resulting from the operator gripping the handle grip 128 and walking in the rearward direction. The handle 102 may include a biasing member or spring 160 (see FIGS. 2, 3, and 4) that biases the handlebar 124 to a handle neutral position (e.g., between forward and reverse) corresponding to zero output of the traction drive system/zero velocity of the mower.

As shown in FIG. 4, the handle grip 128 may be formed by two (e.g., left and right) upwardly converging segments 119 of the handlebar 124, as well as by a transverse section 121 connecting uppermost ends of the converging segments 119. This shape may allow the handlebar to present a continuous hand grip surface to the operator. Moreover, such a shape permits the operator to grasp either: the segments 119, which may permit a more neutral wrist position; or the transverse section 121 should the operator prefer a more horizontal grip. As one of skill may appreciate, other embodiments may provide a handlebar providing any number of hand grip shapes without departing from the scope of this disclosure.

With continued reference to FIG. 4, the handle frame 132 (e.g., the upper portion 131) may further include a support bracket 115 attached to each of the handle tubes 134 and configured to support the handlebar 124 and the force sensor 104. While there may be a force sensor associated with each of the brackets 115, the illustrated embodiments include a single force sensor 104 associated with only one of the brackets (e.g., the left bracket).

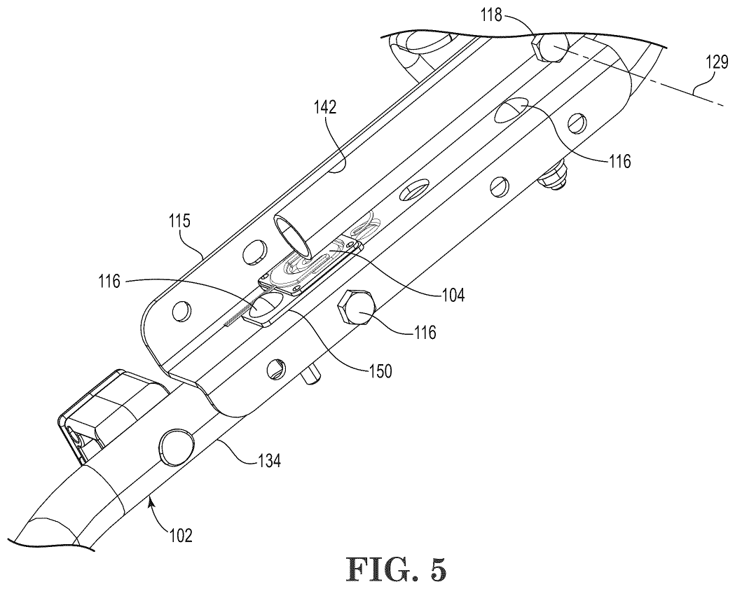

Each bracket 115 may be secured to its respective handle tube 134 using fasteners (e.g., bolts and nuts) 116 as shown in FIG. 4, while each leg 142 of the handlebar 124 may be pivotally attached to its associated bracket with a fastener 118 (only fastener 118 for the left leg 142 shown in FIG. 4). As shown in FIG. 5, one of the fasteners 116 may also secure the force sensor 104 relative to the bracket 115/handle frame as described below.

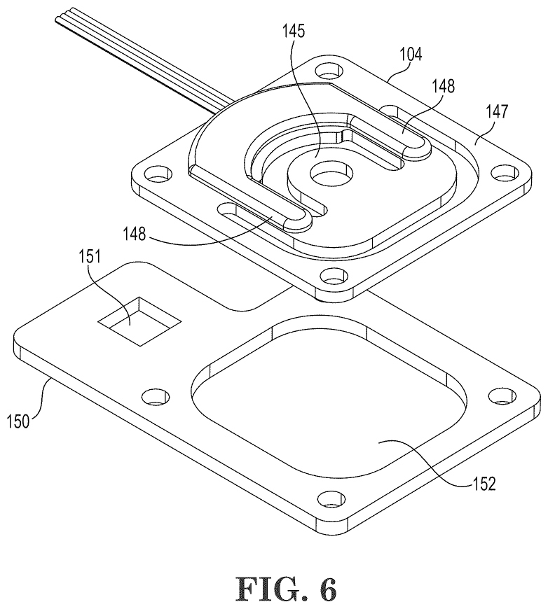

As shown in FIG. 6, the exemplary force sensor 104 may be attached to a mounting plate 150 (both shown in isolation) using fasteners (not shown). The mounting plate 150 is then, in turn, attached to the bracket 115/handle frame 132 (e.g., to one of the handle tubes 134) via an aperture 151 configured to receive one of the fasteners 116 (see also FIG. 5). The mounting plate 150 may support the force sensor 104 around its peripheral edges such that force sensor deflection may be accommodated by a cutout 152.

While the configuration of the force sensor may vary, it is in one embodiment a strain-gaged load cell such as a model GLM670 load cell distributed by Xi'an Gavin Electronic Technology Co., Ltd. (Galoce) of Xi'an, Shaanxi, China. This exemplary force sensor may include a perimeter or base (“stationary” portion) 147 fixed to the mounting plate 150, and a hub (“movable” portion) 145 connected to the base by one or more strain-gaged flexures 148. The hub 145 may be configured to move or deflect relative to the stationary portion via the flexure. When the hub 145 is deflected or displaced relative to the base 147, strain gages attached to the flexure detect a magnitude of strain in the flexure due to the movement and output a voltage signal proportional thereto. Stated more broadly, the force sensor 104 is operatively connected to the handle such that it produces an electrical sensor signal proportional to the force F (see FIG. 7) applied to the handlebar/handle grip. The terms “movement,” “deflection,” “displacement,” and the like of the force sensor are understood herein to refer to the movement of the hub relative to the base due to bending of the flexure.

Accordingly, the force sensor 104 is configured to detect a magnitude of the force F and vary a forward speed of the propulsion motor 117 (see FIG. 2) in proportion to the force F. Again, while described herein as detecting the force F in the forward direction, the force sensor 104 could be (in addition or alternatively) configured to sense a force R (see FIG. 7) in the rearward direction and vary a rearward speed of the propulsion motor in proportion to the force R. The forward and reverse speed control algorithms that vary the speed of the propulsion motor 117 in response to changes in the force F (and/or R) may be linear or non-linear relative to the motion of the handlebar 124. While described herein as using the force sensor 104 to control a speed output of the motor 117/wheels 108 (e.g., open loop or closed loop control), other embodiments may be adapted to, instead or in addition, use signals from the force sensor to control the torque output of the propulsion motor (e.g., again via open or closed loop control).

During mower operation, the operator may apply the forward force F to the handle grip 128 of the handlebar 124 as shown in FIG. 7. As the force is applied, the handlebar may pivot in the direction 155, relative to the handle frame 132/handle tubes 134, about the handlebar pivot 129. As this pivoting occurs, a forward end or “actuator” 153 of the leg 142 (see also FIG. 5), which is offset from the handlebar pivot, may bear downwardly against the hub 145 of the force sensor 104, thereby applying a force Fs to the force sensor. The magnitude of the force Fs applied to the force sensor may vary in proportion to the magnitude of the force F applied to the handlebar due to the moment produced by application of the force F and a distance 156 between the actuator 153 and the handlebar pivot 129.

While shown as bearing directly against the force sensor, the actuator 153 may include an intermediate element, e.g., bearing, bushing, button, etc. The inclusion of such an intermediate element may reduce point or line contact on the force sensor 104. While the intermediate element may be an independent component, it may in other embodiments be attached to the actuator 153 or to the force sensor 104 without departing from the scope of this disclosure. For example, the end of the leg 142 that forms the actuator 153 may simply be flattened to provide additional surface area for force sensor contact.

In response to application of the force Fs, the force sensor 104 is configured to produce an electrical sensor signal corresponding to a magnitude of the force Fs (and thus corresponding to a magnitude of the force F). The sensor signal is received by a controller 120 (see FIG. 2), whereby the controller then generates an electrical drive command signal to the electric propulsion motor 117 (see also FIG. 2) to vary a speed or torque output of the propulsion motor in correspondence to the magnitude of the force F. The relationship between magnitude of the force F and the magnitude of the force Fs may be varied by, for example, changing the distance 156 between the force vector of force Fs and the handlebar pivot 129, and/or changing a distance 158 between the force vector of force F and the handlebar pivot.

In some embodiments, the handlebar geometry may yield a mechanical advantage of 1:1 or greater, e.g., 2:1, between a resulting output force Fs applied to the force sensor and the input force F applied to the handle grip (e.g., Fs:F). For example, for a relatively light spring 160 force, application of a force F by the operator of 13 Newtons (N) (3 pounds-force (lbf)) may, in turn, generate a force Fs applied to the force sensor (via the actuator 153) of 26 N (6 lbf). Of course, the handlebar geometry may be varied to produce different ratios of force F to force Fs without departing from the scope of this disclosure. Moreover, the position of the operator's hands may affect this ratio. For example, if the operator's hands are positioned on the transverse section 121 (see FIG. 4) of the handlebar 124 rather than on the converging segments 119, the ratio may change.

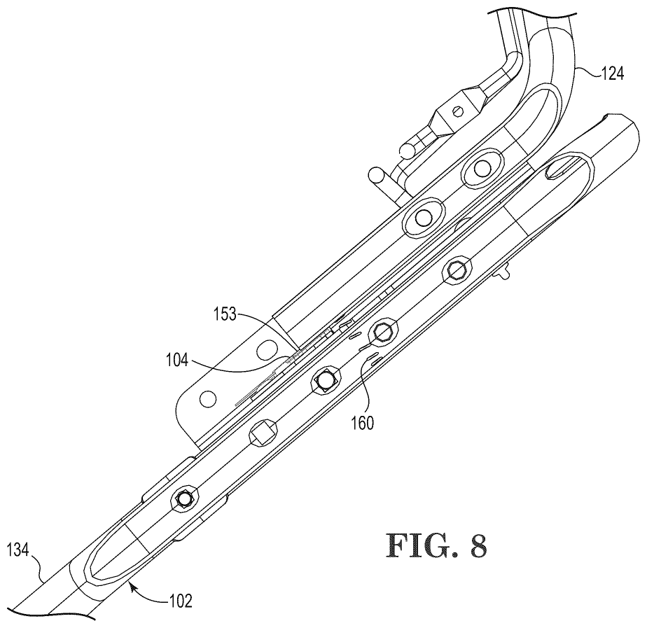

FIG. 8 is a section view taken along line 8-8 of FIG. 3. As shown in this view, the spring 160 may be held captive by insertion through an aperture in the handle tube 134. While shown as a compression spring, the spring 160 may be most any biasing device or member that provides the desired biasing properties, e.g., a torsion spring located at the handlebar pivot 129.

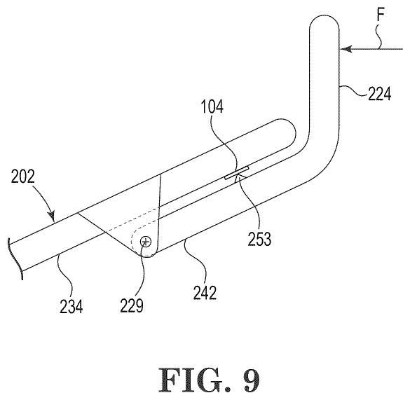

FIG. 9 diagrammatically illustrates an alternative embodiment of a handle 202 for a power equipment unit. As shown in this view, the handle 202 includes at least one, e.g., two handle tubes 234. The tubes may include a bracket that forms a handlebar pivot 229 to which an end of a leg 242 of a handlebar 224 pivotally attaches. As with the handlebar 124, the handlebar 224 includes an actuator 253 adapted to bear against a force sensor 104 as shown. Accordingly, application of the force F to the handlebar 224 will cause the handlebar to pivot (counterclockwise in FIG. 9) about the handlebar pivot 229. As this motion occurs, the actuator 253 will compress the force sensor 104 as already described herein.

As one of skill can appreciate, the embodiment illustrated in FIG. 9 operates in a similar fashion to the handle 102. However, the handle 202 locates the leg 242, actuator 253, and force sensor beneath, rather than above, the handle tube 234. Accordingly, while the handlebar pivot of the handle 102 is operatively positioned between the grip and the actuator of the handlebar (“see-saw” configuration), the handle 202 operatively positions the actuator between the handlebar pivot and the grip. Similarly, with the handle 102, the handlebar pivot is at an elevation relative to the ground surface that is greater than an elevation of the force sensor, while with the handle 202, the handlebar pivot is at an elevation relative to the ground surface that is less than an elevation of the force sensor.

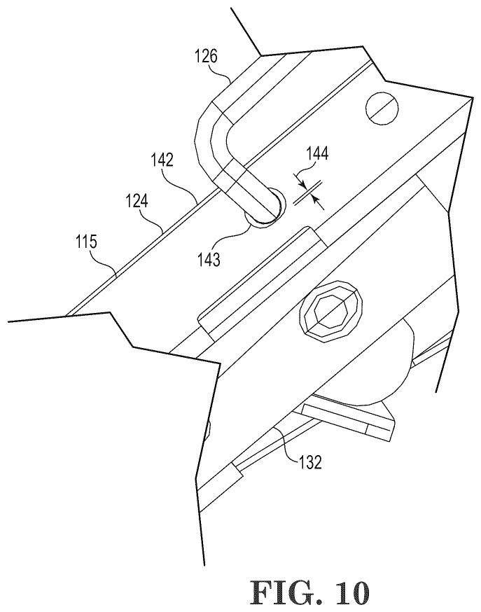

In some embodiments a stop may be used to limit the maximum force that may be applied to the force sensor, e.g., to prevent sensor damage. For example, such a stop may be located under the force sensor to limit the deflection of the hub 145, e.g., a thickness of the mounting plate may be selected to ensure that the hub 145 of the force sensor “bottoms out” against an outer surface of the support bracket 115 before sensor damage occurs. Alternatively, as shown in FIG. 10 (view taken along line 10-10 of FIG. 3), the stop may be built into one or both of the support brackets 115. For instance, the bail 126 may be supported by apertures formed in each of the legs 142 of the handlebar 124 after first passing through an aperture 143 formed in each of the support brackets 115. The apertures 143 may be sized to constrain the bail 126 (and accordingly the handlebar 124) within a given pivotal movement range. When the handlebar 124 is in a neutral position as shown in FIG. 10, the bail 126 may be spaced apart from an inner surface of the aperture 143 by a distance 144. As the handlebar 124 is displaced due to the force F, the bail 126 may move (downwardly in FIG. 10) toward the inner surface. As one can appreciate, the inner surface of the aperture may thus form a hard stop for limiting pivotal motion of the bail 126/handlebar 124. While not shown, an opposite inner surface of the aperture 143 may form a hard stop for pivoting of the handlebar 124 in the opposite direction (e.g., as a result of application the force R in the reverse direction).

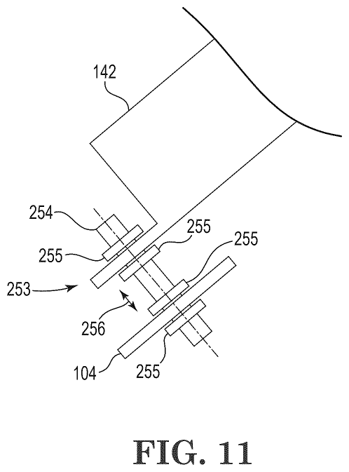

FIG. 11 diagrammatically illustrates an actuator 253 in accordance with another embodiment of this disclosure. The actuator 253 may be substituted for the actuator 153 already described herein for applications in which the handlebar 124/force sensor 104 are configured to detect both forward (force F; see FIG. 7) and rearward (force R) forces applied to the handlebar. As shown in this view, the actuator 253 may include a threaded rod 254 that extends with clearance through both the leg 142 and the force sensor 104 as shown. Nuts 255 may then be used to capture both the leg 142 and force sensor 104 on the rod 254 (the nuts 255 may include jam nuts (not shown) or fiber locks to restrain the nuts on the rod 254). In this configuration, the handlebar may be capable of transmitting a force to the load cell both in the forward direction and the reverse direction as indicated by arrows 256. Moreover, the adjustability provided by the nuts 255 may allow fine tuning of the relative motion, zero points, etc. during manufacturing and subsequent thereto. Still further, the nuts may allow for setting or limiting backlash in handlebar motion.

As shown in FIG. 2, the mower 100 may include the controller 120 adapted to monitor and control various mower functions. In some embodiments, the controller 120 may include a processor 122 that receives various inputs and executes one or more computer programs or applications stored in memory 123. The memory 123 may include computer-readable instructions or applications that, when executed, e.g., by the processor 122, cause the controller 120 to perform various calculations and/or issue commands. That is to say, the processor 122 and memory 123 may together define a computing apparatus operable to process input data and generate the desired output to one or more components/devices. For example, the controller (e.g., processor 122) may receive various input data including sensor signals from the force sensor 104 and generate electrical drive (e.g., speed or torque) command signals to the propulsion motor 117, thereby varying the ground speed of the housing in correspondence with the force F applied to the handlebar. While described with some specificity herein, the term “controller” may be used to describe components that receive inputs and provide corresponding outputs or commands to other mower systems/components.

In addition to the force sensor, the controller 120 may communicate with other mower systems including the battery pack 111 and motors 114, 117. In some embodiments, a slope sensor 178 may be carried on housing 106 and shown in FIG. 2. The slope sensor 178 may be connected to the controller 120 to provide data on slope or angle of the housing 106, e.g., about a horizontal axis defined by the ground surface 101. In some embodiments, the controller 120 may receive input from the slope sensor and, when the slope exceeds a predetermined threshold, automatically increase (or decrease) velocity or torque output of the propulsion motor 117 as the mower climbs (or descends) a hill. The magnitude of the compensation provided by the controller is designed to allow the operator to maintain the same walking pace without having to push harder on the handlebar 124. For example, as the mower 100 is driven forwardly up a hill, the controller 120 may increase the torque of the motor 117 from the value that would otherwise correspond to force sensor deflection to compensate for the addition load.

In some embodiments, a sensitivity adjustment control 174 may also be provided to allow the operator to select how quickly the mower 100 responds to the force F applied to the handlebar 124. This may be achieved by having a multi-position switch (not shown) mounted on the mower 100, with such switch having different sensitivity settings. Rather than using a physical switch carried on the mower 100, the sensitivity adjustment control 174 could be configured as a remote user interface connected to the mower via a wired or wireless connection (e.g., a smartphone application, etc.).

It will be readily apparent that the functionality of the controller 120 may be implemented in any manner known to one skilled in the art. For instance, the memory 123 may include any volatile, non-volatile, magnetic, optical, and/or electrical media, such as a random-access memory (RAM), read-only memory (ROM), non-volatile RAM (NVRAM), electrically-erasable programmable ROM (EEPROM), flash memory, and/or any other digital media. While shown as both being incorporated into the controller 120, the memory 123 and the processor 122 could be contained in separate modules.

The processor 122 may include any one or more of a microprocessor, a controller, a digital signal processor (DSP), an application specific integrated circuit (ASIC), a field-programmable gate array (FPGA), and/or equivalent discrete or integrated logic circuitry. In some embodiments, the processor 122 may include multiple components, such as any combination of one or more microprocessors, one or more controllers, one or more DSPs, one or more ASICs, and/or one or more FPGAs, as well as other discrete or integrated logic circuitry. The functions attributed to the controller 120 and/or processor 122 herein may be embodied as software, firmware, hardware, or any combination thereof.

The force sensor 104 may provide an input signal to the controller 120 (e.g., representative of the force applied to handlebar 124 by the operator) as a plus or minus voltage signal ranging from zero voltage (when the handle grip is in the handle neutral position) to a higher voltage (when the handle grip is in the handle maximum forward position). The controller 120 may then drive the mower 100 in the forward direction in proportion to the magnitude of the voltage signal. In some embodiments, the force sensor may be preloaded such that, when the sensor is in a sensor neutral position (corresponding to the handle grip being in a handle neutral position, e.g., no force F applied), the force sensor outputs a voltage signal greater than zero. Such a preload may be useful to, for example, reduce backlash.

As stated above, while voltage control of the propulsion motor 117 is contemplated, the controller may also provide torque control of the propulsion motor by varying the current supplied to the motor 117 (rather than varying voltage). Changing the voltage supplied to the motor 117 can quickly change the rotational speed of the drive wheels 108 and may lead to “jumpy” responses or allow the drive wheels 108 to slip as the mower 100 accelerates. Even with such torque control however, the controller 120 may limit how quickly motor voltage can ramp to assist with minimizing wheel slippage. While such control uses both current and voltage commands, other controllers could employ either current or voltage control alone.

Various other modifications are also contemplated. For example, the handlebar 124 could be formed as the cross member 136 of the handle frame 132 as long as the cross member could pivot relative to the handle tubes 134 by an amount sufficient to fully actuate the force sensor 104. Moreover, while shown as using a single force sensor 104, two force sensors could be provided. Such dual force sensors could be placed in parallel with one force sensor 104 being mounted to each handle tube 134 as an example. Alternatively, the dual force sensors 104 could be placed perpendicularly to each other with one force sensor extending along a handle tube and the other force sensor extending laterally side-to-side. In either configuration, the use of two force sensors 104 could detect a difference in the force applied by the operator to laterally spaced portions (e.g., convergent segments 119) of handlebar 124. This detected lateral difference in the applied force could then be used by the controller 120 to control separate propulsion motors (one associated with each drive wheel) for effectively power steering the mower 100. Alternatively, the signals from both of the two force sensors 104 could be averaged to account for operators who are more dominant with one hand.

Illustrative embodiments are described and reference has been made to possible variations of the same. These and other variations, combinations, and modifications will be apparent to those skilled in the art, and it should be understood that the claims are not limited to the illustrative embodiments set forth herein.

1. A power equipment unit comprising:
a housing carrying a working implement;
ground-engaging members configured to support the housing upon a ground surface;
an electric motor operatively connected to, and adapted to selectively power, one or more of the ground-engaging members to propel the housing over the ground surface at a variable ground speed;
a handle comprising: a handle tube having a proximal end attached to the housing and extending away from the housing to terminate at a distal end; and a handlebar pivotally mounted to the handle tube at a handlebar pivot, wherein the handlebar comprises:
a grip configured to be grasped by an operator during operation of the power equipment unit whereby the handlebar pivots about the handlebar pivot relative to the handle tube in response to a force F applied to the grip; and
an actuator that is offset from the handlebar pivot;
a force sensor operatively connected to the handle tube and configured to contact the actuator such that the actuator, in response to pivotal motion of the handlebar about the handlebar pivot, imparts a force Fs to the force sensor, the force sensor configured to produce an electrical sensor signal corresponding to the force F; and
a controller that receives the sensor signal and generates an electrical drive command signal to the electric motor to vary a speed or torque output of the electric motor in correspondence to a magnitude of the force F.

2. The power equipment unit of claim 1, wherein the handlebar pivot is located at or near the distal end of the handle tube.

3. The power equipment unit of claim 1, wherein the handlebar pivot is operatively positioned between the grip and the actuator of the handlebar.

4. The power equipment unit of claim 1, wherein the force sensor is operatively positioned between the grip and the handlebar pivot.

5. The power equipment unit of claim 1, wherein the force sensor comprises a load cell.

6. The power equipment unit of claim 1, wherein the force sensor is located along an upper surface of the handle tube.

7. The power equipment unit of claim 1, wherein the force Fs is applied to the force sensor perpendicular to an axis of the handle tube.

8. The power equipment unit of claim 1, further comprising a spring configured to bias the handlebar, about the handlebar pivot, toward a neutral position.

9. The power equipment unit of claim 1, wherein the handle tube comprises first and second handle tubes joined together by a cross member at their respective distal ends, and wherein the handlebar comprises first and second actuators proximate the first and second handle tubes, respectively.

10. The power equipment unit of claim 9, wherein the force sensor comprises first and second force sensors operatively connected to the first and second handle tubes, respectively.

11. The power equipment unit of claim 1, wherein relative positions of the grip, handlebar pivot, and handlebar actuator are configured to provide a ratio of forces Fs:F of 1:1 or greater.

12. A power equipment unit comprising:
a housing carrying a ground-working implement;
wheels configured to support the housing upon a ground surface;
an electric motor operatively connected to, and adapted to selectively power, one or more of the wheels to propel the housing over the ground surface at a variable ground speed;
a handle comprising: a handle tube having a proximal end attached to the housing and extending away from the housing to terminate at a distal end; and a handlebar pivotally mounted to the handle tube at a handlebar pivot, wherein the handlebar comprises:
a grip configured for grasping by an operator during operation of the power equipment unit whereby the handlebar pivots about the handlebar pivot relative to the handle tube in response to a force F applied to the grip; and
an actuator that is offset from the handlebar pivot;
a force sensor operatively connected to the handle tube and proximate the actuator, wherein in response to pivotal motion of the handlebar about the handlebar pivot, a force Fs is imparted by the actuator to the force sensor, and wherein the force sensor is configured to produce an electrical sensor signal corresponding to the force F; and
a controller configured to receive the sensor signal and generate an electrical drive command signal to the electric motor to vary a speed or torque output of the electric motor in correspondence to a magnitude of the force F.

13. The power equipment unit of claim 12, wherein the force F applied at the grip produces a moment of the handlebar about the handlebar pivot.

14. The power equipment unit of claim 12, wherein the handle tube comprises first and second handle tubes joined together by a cross member at their respective distal ends, and wherein the handlebar comprises a U-shaped structure pivotally mounted to both of the first and second handle tubes.

15. The power equipment unit of claim 12, wherein the grip is at an elevation relative to the ground surface that is greater than an elevation of the handlebar pivot.

16. The power equipment unit of claim 12, wherein the handlebar pivot is at an elevation relative to the ground surface that is greater than an elevation of the force sensor.

17. The power equipment unit of claim 12, wherein the handlebar pivot is at an elevation relative to the ground surface that is less than an elevation of the force sensor.

18. The power equipment unit of claim 12, further comprising a sensor attached to the grip.
